(19) United States
(12) Patent Application Publication
(10) Pub. No.: US 2008/0270066 A1
(43) Pub. Date: Oct. 30, 2008

(54) SENSOR MIDDLEWARE SYSTEMS AND AGENTS WITH SENSOR MIDDLEWARE SYSTEMS

(75) Inventors: Robert A. Blaser, Glendale, AZ (US); Mahesh K. Jeerage, New Brighton, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/741,506

(22) Filed: Apr. 27, 2007

(51) Int. Cl. G06F 15/00

(52) U.S. Cl. 702/127

(57) ABSTRACT

An agent for performing a mission function is provided. The agent includes at least one sensor for collecting data related to the mission function; and a sensor middleware system. The sensor middleware system includes a physical interface module including at least one socket for receiving the at least one sensor, a fault tolerance and sensor fusion module coupled to the physical interface, the fault tolerance and sensor fusion module configured to detect faults in the at least one sensor, and a mission services module coupled to the physical interface module and including algorithms for performing the mission function based on the data from the at least one sensor.

### FIELD OF THE INVENTION

The present invention generally relates to sensor middleware systems and agents with sensor middleware systems, and more particularly relates to sensor middleware systems that enable improved sensor upgrades.

### BACKGROUND OF THE INVENTION

The Vision for Space Exploration charges NASA with developing space agents for exploring the Moon and Mars with manned and unmanned missions. Implementation of this vision requires current best-in-class sensor technology, as well as the ability to incorporate emerging sensor technology as the new technology becomes available. For example, automated rendezvous and docking (AR&D) is one area that utilizes adaptive and fault tolerant sensor systems and would benefit from current and future sensor upgrades and extensibility in both surface operations and space science activities. However, because frequently launching new hardware for sensor systems into space involves large financial costs, the ability to reconfigure existing sensor systems that are already deployed in space is important. Currently, conventional sensor systems have hardware and software that are difficult to replace or repair. Moreover, in addition to the space applications, sensor systems in military applications and other harsh environments may also be unsatisfactory with respect to adaptation and reconfiguration functionality.

Accordingly, it is desirable to provide sensor middleware systems that support current and future sensors, thereby enabling improved implementation of repair, replacement, and maintenance. In addition, it is desirable to provide agents with sensors and sensor middleware systems that support sensor upgrades and extensibility. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An agent for performing a mission function is provided in accordance with an exemplary embodiment of the present invention. The agent includes at least one sensor for collecting data related to the mission function; and a sensor middleware system. The sensor middleware system includes a physical interface module including at least one socket for receiving the at least one sensor, a fault tolerance and sensor fusion module coupled to the physical interface, the fault tolerance and sensor fusion module configured to detect faults in the at least one sensor, and a mission services module coupled to the physical interface module and including algorithms for performing the mission function based on the data from the at least one sensor.

A sensor middleware system is provided in accordance with an exemplary embodiment of the present invention. The sensor middleware system includes a physical interface module including at least one socket for receiving at least one sensor; a fault tolerance and sensor fusion module coupled to the physical interface, the fault tolerance and sensor fusion module configured to detect faults in the at least one sensor; and a mission services module coupled to the physical interface module and including algorithms for performing a mission function based on data from the at least one sensor.

### BRIEF DESCRIPTION OF THE DRAWINGS

The present invention will hereinafter be described in conjunction with the following drawing figures, wherein like numerals denote like elements, and wherein:

FIG. 1 is a block diagram of an agent with a sensor middleware system in accordance with an exemplary embodiment of the present invention; and

FIG. 2 is a block diagram of sensor middleware system that can be utilized independently or as part of the agent of FIG. 1.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

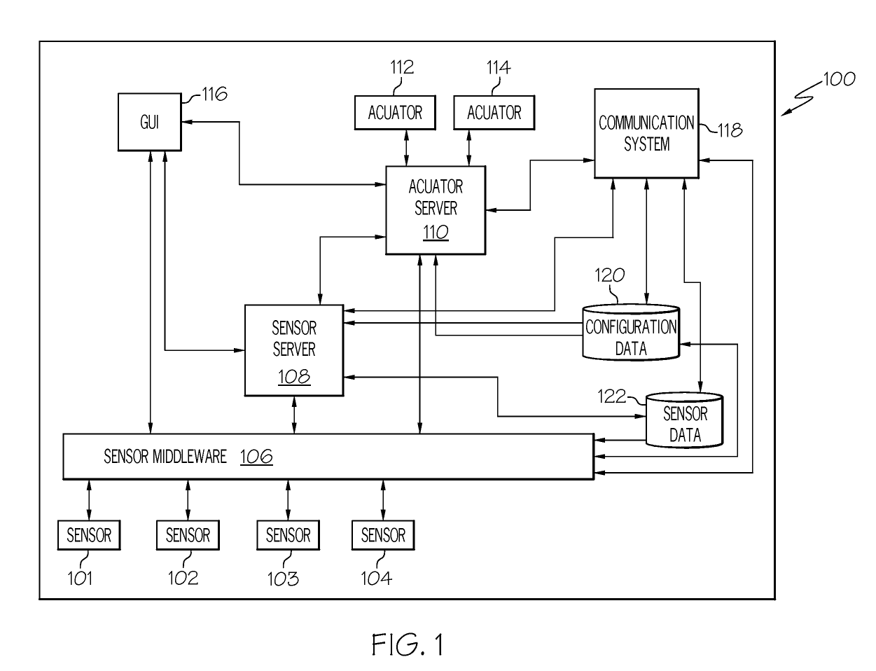

FIG. 1 illustrates an agent 100 for performing a mission function. In one exemplary embodiment, the agent 100 can be a vehicle suitable for space missions. For example, the agent 100 can be a vehicle and the components in the vehicle can be dedicated to rendezvous and docking of the vehicle. In other embodiments, the agent 100 can be utilized for mission management function support, such as interplanetary or battlefield mission management, or other applications in hostile, dangerous, or remote environments. In other embodiments, the agent 100 can be utilized to support remotely located control systems, such as off-shore oil production rigs, remote seismic sensing systems or remote weather and/or scientific data gathering systems. The agent 100 can be utilized as a robot, and can be mobile or stationary, depending on the mission function. The agent 100 can be an individual agent or part of a larger grouping of agents. Moreover, the agent 100 can be manned or unmanned. The agent 100 may also be capable of complex mode or state switching, such as “awakening” from a quiescent state based upon receipt of external or timed stimuli.

The agent 100 includes a plurality of sensors 101-104. The sensors 101-104 collect data for use by the agent 100 in its mission or control function, or for use outside of the agent 100. The sensors 101-104 may also internally respond to collected data, or respond to externally received or timed stimuli. The sensors 101-104 can be passive sensors or active sensors. Generally, passive sensors merely pass the collected raw data, while active sensors can perform at least some processing on the data, such as responding to the data, measuring the data, and fault tolerance. For example, the sensors 101-104 may reconfigure data gathering modes and/or states based upon collected data or stimuli or based upon the receipt of reconfiguration commands. Moreover, the sensors 101-104 may be able to respond to received or collected data, or respond to externally received or timed stimuli. The sensors 101-104 can include, but are not limited to, communication sensors, light-based or optical sensors, spectral sensors, acoustic sensors, thermal sensors, chemical sensors, radiological sensors, nuclear sensors and radar sensors. Other types of sensors can also be provided.

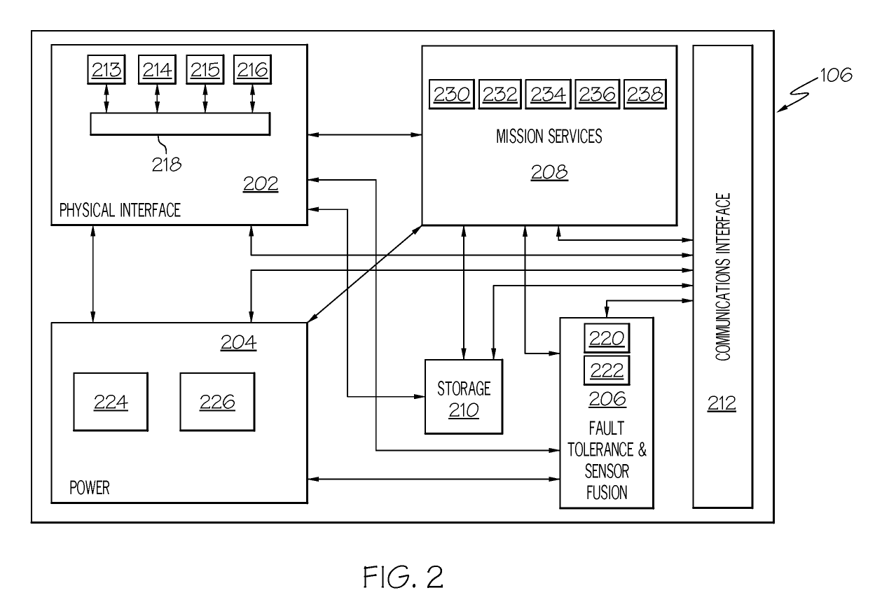

The sensors 101-104 are coupled to a sensor middleware system 106. In one embodiment, the sensor middleware system 106 provides an interface between the sensors 101-104 and a sensor server 108. In general, the sensor middleware system 106 provides a level of autonomy at the sensor level and enables hardware interface standardization and sensor optimization for long-term system reconfiguration and re-use. The sensor middleware system 106 separates and abstracts the sensors 101-104 from the remaining portions of the agent 100. As further discussed below in reference to FIG. 2, the separation and abstraction provides the mechanisms to support multiple sensor interfaces, perform redundancy management and sensor fusion, perform power distribution and power usage optimization and apply genetic algorithms to perform specific mission and control systems functions. The sensor middleware system 106 also provides a conduit for receiving sensor reconfiguration information and sensor stimuli, and for supplying commands to the sensors 101-104.

The sensor server 108 collects the data from the sensors 101-104 via the sensor middleware system 106 and processes the data. The processed data can be provided to an actuator server 110. The actuator server 110 provides commands to one or more actuators 112 and 114. The actuators 112 and 114 can be actuators related to the mission of the agent 100. In one embodiment, the actuators 112 and 114 can be related to steering, guidance, and speed of the agent 100. For example, the actuators 112 and 114 can actuate thrust pulses and mechanical docking and latching mechanisms.

The sensor server 108 and the actuator server 110 each communicates with a graphical user interface (GUI) 116. The sensor middleware system 106 can also be coupled to the GUI 116. The GUI 116 enables a user or controller of the agent 100 to view the processes, status, and results of the system, and additionally, enables the user or controller to provide inputs to the agent 100.

A communication system 118 also forms part of the agent 100 and is coupled to the sensor server 108 and the actuator server 110. The sensor middleware system 106 can also be coupled to the communication system 118. The communication system 118 enables the agent 100 to communicate with offboard controllers, as well as access offboard databases and systems. The communication system 118 can be realized as transmitter and receiver hardware coupled with commutation and decommutation hardware, firmware and algorithms, as well as encryption algorithms and information transport protocols.

The agent 100 additionally includes one or more databases 120 and 122. A configuration database 120 is coupled to the communication system 118, the sensor server 108, the sensor middleware system 106, and the actuator server 110. The configuration database 120 provides sensor and actuator configuration data to the sensor server 108 and actuator server 110, respectively, as well as offboard parties via the communication system 118. A sensor database 122 is coupled to the communication system 118, the sensor server 108, the sensor middleware system 106, and the actuator server 110. The sensor database 122 stores historical sensor data, and provides and receives data from the sensor middleware system 106 and sensor server 108.

As discussed in further detail below, certain components of the agent can be omitted. For example, the function of the sensor server 108, the actuator server 110, and communication system 118 can be incorporated into the sensor middleware system 106. The GUI 116 can either be omitted or incorporated into the sensor middleware system 106. Similarly, the databases 120 and 122 can either be incorporated into the sensor middleware system 106, accessed offboard, or omitted from the agent 100. Depending on the mission function, the actuators 112 and 114 and actuator server 110 may not be necessary. For example, no actuation is necessary if the mission merely involves the collection of data.

While the agent 100 has been discussed generally, the sensor middleware system 106 will now be discussed in greater detail with reference to FIG. 2. The sensor middleware system 106 includes one or more interconnected modules 202, 204, 206, 208, and 210. The modules, or layers, include a physical interface module 202, a power module 204, a fault tolerance and sensor fusion module 206, a mission services module 208, and a storage and retrieval module 210. The modules 202, 204, 206, 208, and 210 are coupled to the other portions of the agent 100, as well as outside systems and agents (not shown), with a communications interface 212.

The physical interface module 202 provides an interface for the plurality of sensors 101-104, and in one exemplary embodiment, is coupled to the power module 204, the fault tolerance and sensor fusion module 206, the mission services module 208, the storage and retrieval module 210, and the communication interface 212. The physical interface module 202 includes a plurality of sockets 213-216 for physical and electrical connection with the sensors 101-104. The sockets 213-216 are “plug-and-play” interfaces that enable a sensor to be switched out for a replacement or upgraded sensor. This provides an improved extensibility for the sensor middleware system 106 and the agent 100 because new sensors can be incorporated into the physical interface module 202 as new sensors are developed. The physical interface module 202 additionally includes a sensor interface processor 218 coupled to the sockets 213-216. The sensor interface processor 218 includes sensor interface schema that includes the sensor interface information content, specifications, and protocols for the various types of sensors that are to be coupled to the physical interface module 202 via the sockets 213-216. The sensor interface processor 218 may include memory for storing the information content, specifications, and protocols, or the sensor interface processor 218 may receive such information from other sources. During operation, the sensor interface processor 218 receives the data from the sensors 101-104 in the sockets 213-216 and may normalize the data to provide the data in a useful format to other components in the sensor middleware system 106 or the agent 100.

The power module 204 provides a central power supply to the sensors 101-104 in the sockets 213-216, and in one embodiment, is coupled to the physical interface module 202, the fault tolerance and sensor fusion module 206, the mission services module 208, the storage and retrieval module 210, and the communication interface 212. As such, the power module 204 reduces power requirements of individual sensors 101-104 by providing a complimentary or replacement power supply to the sensors 101-104. In some embodiments, this enables the sensors 101-104 to omit any individual power supplies. The power module 204 has a power collector 224. The power collector 224 can be, for example, a solar power collector or a generator collector for control systems that provide a power generator source. The power module 204 can additionally include a power distributor 226 that distributes the power from the power collector 224 to the sockets 213-216 for use by the sensors 101-104. The power distributor 226 can evenly distribute power to the sensors 101-104, or the power distributor 226 can prioritize power distribution to the sensors 101-104 based on either the power consumption of each sensor 101-104 or the importance of each sensor 101-104 to the mission function. The power distributor 226 may respond to commands, stimuli and missions modes so as to minimize or reduce power utilization of the sensors 101-104 as necessary or desired.

The fault tolerance and sensor fusion module 206 includes one or more processors 220 and 222 for managing the information content and health of the sensors 101-104 coupled to the sockets 213-216 in the physical interface module 202. In one embodiment, the fault tolerance and sensor fusion module 206 is coupled to the physical interface module 202, the power module 204, the mission services module 208, the storage and retrieval module 210, and the communication interface 212. In the illustrated embodiment, the processors 220 and 222 can be a fault tolerance processor 220 and a sensor fusion processor 222. Although FIG. 2 depicts the fault tolerance processor 220 and the sensor fusion processor 222 as separate processors, in other embodiments, their functions can be performed by a single processor. Moreover, in an alternate embodiment, the fault tolerance and sensor fusion functionalities can be performed by separate modules.

The fault tolerance processor 220 performs at least the following functions: detection of sensor faults; containment and/or masking of sensor faults; diagnosis, repair and/or reconfiguration to remedy the sensor faults; and recovery and continued service of the sensors 101-104, the sensor middleware system 106, and the agent 100. A sensor fault can be, but is not limited to, a degraded sensor, an occluded and/or blocked sensor, and/or a sensor that has experienced a physical failure. As a general matter, the fault tolerance processor 220 can monitor the sensors 101-104 and provide input to an integrated health management system that manages the health state of the components of the sensor middleware system 106 and the sensors 101-104. In one embodiment, the fault tolerance processor 220 provides automated health self-assessment and monitoring, on-demand maintenance scheduling, and response advisories. Moreover, the fault tolerance processor 220 can detect degradations from deviations in system behavior, analyze performance and resource usage, and use this information to determine when maintenance is necessary to preserve system functionality and minimize downtime. The fault tolerance processor 220 can also provide adaptations for the mitigation of sensor faults. In general, the fault tolerance processor 220 enables the sensor middleware system 106 to continue to properly operate after a fault has occurred. For example, if two sensors 101-104 are the same type, and one has failed or degraded, the fault tolerance processor 220 detects the failure and mitigates or eliminates the possibility of degradation of the sensor middleware system 106 and the sensors 101-104, for example, by prioritizing the data content of the working sensor or eliminating the influence of the failed or degraded sensor. As such, the fault tolerance processor 220 also provides desensitization of weaker and/or intermittent sensors and/or sensors that are blocked or non-functional, such as for example, due to a specific mission phase or environment. The fault tolerance functionality can include determining the type of sensor 101-104, determining the current mission of the agent 100, and determining the health status of the sensors 101-104. The health status determination can include, upon fault detection, de-rating the faulty sensor; mitigating fault in fusion process, as discussed in further detail below; mitigating physical failures in redundancy management process; and reporting and recording health status. Upon sensor fault recovery, the heath status determination includes re-rating the recovered sensor; updating sensor fusion process to make use of recovered sensor; relegating recovered physical failures to “secondary use” status; and reporting and recording health status.

The sensor fusion processor 222 can provide an aggregation of the data received from the sensors 101-104 supported by the physical interface module 202. Particularly, the aggregation includes the normalization of the data and information and a determination of responses to issues in the agent 100 or the sensor middleware system 106. As noted above, the sensor fusion processor 222 can receive information from the fault tolerance processor 220 that can dictate how the sensor fusion processor 222 processes and aggregates the data. In general, normalization provides sensor data in a common form that abstracts hardware differences, such as scaling differences, unit differences and endian differences, so as to ensure a common data format exists for computation and fusion activities. In the agent 100, this data typically relates to relative position, velocity, and attitude. The sensor fusion processor aggregates the data such that the resulting information is superior to sensor data considered individually. The data may be more accurate, more complete, more dependable, or provide an enhanced view, such as stereoscopic vision.

The mission services module 208 provides responsive applications based upon the data received from the fault-tolerance and sensor fusion module 206. In one embodiment, the mission services module 208 is coupled to the physical interface module 202, the power module 204, the fault tolerance and sensor fusion module 206, the storage and retrieval module 210, and the communication interface 212. The mission services module 208 includes a plurality of algorithms 232, 234, 236, and 238 for providing the proper responses to the data to accomplish the mission function. As examples, the mission services module 208 includes algorithms related to integrated systems health management (ISHM) 230, guidance navigation and control (GN&C) 232, visualization and pattern matching 234, data mining 236, and neural networking 238. The mission services module 208 can include genetic algorithms 230, 232, 234, 236, and 238 that understand the environment of the agent 100 and can adapt the output of the algorithms or the algorithm itself based on the particular data from the sensors 101-104. The algorithms 230, 232, 234, 236, and 238 can further be intelligent and/or adaptive to a mode of the agent 100. The mode of the agent 100 corresponds to the current function of the agent. Examples of modes of the agent 100 can include, but are not limited to, ascent, orbit-insertion, rendezvous, proximity operations, and docking and surface operations. As an example, if the agent 100 is in a docking mode, the GN&C algorithm 232 may utilize the data from certain types of sensors 101-104 in assisting in the final capture determinations. If the agent 100 is in a surface operations mode, the GN&C algorithm 232 allows the sensors 101-104 to assist in different types of functions, such as soil sampling and monitoring. The algorithms 230, 232, 234, 236, and 238 can provide a hierarchical allowance of the sensors 101-104 to support different types of functions supporting varying levels of autonomy at the sensor level.

Generally, the mission services module 208 provides the output that accomplishes the mission function. In the embodiment with agent 100 of FIG. 1, the output from the mission services module 208 is provided to the actuator server 110 such that the actuators 112 and 114 can perform a desired function, or the output from the mission services module 208 can be provided to an offboard station or other agent. New algorithms can be uploaded to the mission services module 208 by the communication interface 212 as necessary or desired. The ability to upload new algorithms provides additional extensibility.

The storage and retrieval module 210 provides an interface between the sensor middleware system 106 and databases outside of the sensor middleware system 106. In one embodiment, the storage and retrieval module 210 is coupled to the physical interface module 202, the power module 204, the fault tolerance and sensor fusion module 206, the mission services module 208, and the communication interface 212. The storage and retrieval module 210 can provide access to, for example, the sensor database 122 and the configuration database 120 (FIG. 1). The storage and retrieval module 210 can be non-volatile memory such as flash memory or other suitable memory devices or systems. The storage and retrieval module 210 can also make sensor data from the fault tolerance and sensor fusion module 206 and the mission services module 208 available to other portions of the agent 100 or to offboard controllers for functions such as data mining and/or neural network functions.

As noted above, the modules 202, 204, 206, 208, and 210 are coupled to the communication interface 212. The communication interface 212 makes data from any of the modules 202, 204, 206, 208, and 210 available to other portions of the agent 100, such as the sensor server 108, the actuator server 110, and/or offboard controllers. The communication interface 212 also receives information to be provided to the various modules 202, 204, 206, 208, and 210 of the sensor middleware system 106. As an example, the communication interface 212 can upload new adaptive and genetic algorithms 230, 232, 234, 236, and 238 for the mission services module 208. The communication interface 212 additionally provides off-board sensor reconfigurations, supervisory control of the sensors, and changes in autonomic control. The communications interface 212 also provides a mechanism for delivering advisories to and from the sensor middleware modules 202, 204, 206, 208, and 210. The communication interface 212 can communicate appropriate levels of authority and autonomy to the various modules 202, 204, 206, 208, and 210 of the sensor middleware system 106. Accordingly, the communication interface 212 can enable a hierarchical scheme of the sensors 101-104 of the sensor middleware system 106 relative to the agent 100 and additionally relative to higher systems. If necessary, the communication interface 212 can maintain radio silence depending on commands, stimuli and missions modes. The communication interface 212 can be realized as transmitter and receiver hardware coupled with commutation and decommutation hardware, firmware and algorithms, as well as encryption algorithms and information transport protocols.

Exemplary embodiments of the present invention provide NASA and other customers a complete architecture for efficient upgrades of remote sensor-based systems, including AR&D systems. This reduces operational costs and enables missions that would otherwise be cost-prohibitive, mission-prohibitive and/or time-prohibitive. The use of standardization in the sensor middleware system 106 encourages COTS element standardization and provides replacement alternatives. The sensor middleware system 106 provides improved extensibility with the capability to reconfigure itself with updated sensor protocols and algorithms and an increased level of autonomy at the sensor level. The sensor middleware system 106 can additionally provide intelligent power distribution to the sensors 101-106.

Although FIG. 1 illustrates the sensor middleware system 106 as forming part of one type of agent 100, the sensor middleware system 106 can be utilized in many types of autonomous systems. For example, the sensor middleware system 106 can be utilized in Department of Defense surveillance and sensor fusion activities, responsive space initiative adaptability requirements, Homeland Security and Border Control applications, and integrated system health management for any autonomous system.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. An agent for performing a mission function, comprising:
at least one sensor for collecting data related to the mission function; and
a sensor middleware system comprising
a physical interface module including at least one socket for receiving the at least one sensor,
a fault tolerance and sensor fusion module coupled to the physical interface, the fault tolerance and sensor fusion module configured to detect faults in the at least one sensor, and
a mission services module coupled to the physical interface module and including algorithms for performing the mission function based on the data from the at least one sensor.

2. The agent of claim 1, further comprising a power module coupled to the physical interface module and configured to provide power to the at least one sensor.

3. The agent of claim 2, wherein the power module comprises a power collector and a power distributor coupled to the power collector.

4. The agent of claim 1, wherein the at least one socket is a plug and play interface.

5. The agent of claim 1, wherein the physical interface module further includes a sensor interface processor that includes information related to the at least one sensor.

6. The agent of claim 1, wherein the fault tolerance and sensor fusion module provides an integrated health management system.

7. The agent of claim 1, wherein the fault tolerance and sensor fusion module is configured to aggregate the data collected by the at least one sensor.

8. The agent of claim 1, wherein the algorithms include genetic and adaptive algorithms.

9. The agent of claim 1, further comprising a communication interface coupled to sensor middleware system.

10. The agent of claim 9, wherein the communication interface is configured to receive and download algorithms for the mission services module.

11. The agent of claim 1, further comprising at least one actuator coupled to the sensor middleware system for performing the mission function.

12. A sensor middleware system, comprising:
a physical interface module including at least one socket for receiving at least one sensor;
a fault tolerance and sensor fusion module coupled to the physical interface, the fault tolerance and sensor fusion module configured to detect faults in the at least one sensor; and
a mission services module coupled to the physical interface module and including algorithms for performing a mission function based on data from the at least one sensor.

13. The sensor middleware system of claim 12, further comprising a power module coupled to the physical interface module and configured to provide power to the at least one sensor.

14. The sensor middleware system of claim 13, wherein the power module comprises a power collector and a power distributor coupled to the power collector.

15. The sensor middleware system of claim 12, wherein the at least one socket is a plug and play interface.

16. The sensor middleware system of claim 12, wherein the physical interface module further includes a sensor interface processor that includes information related to the at least one sensor.

17. The sensor middleware system of claim 12, wherein the fault tolerance and sensor fusion module provides an integrated health management system.

18. The sensor middleware system of claim 12, wherein the fault tolerance and sensor fusion module is configured to aggregate the data collected by the at least one sensor.

19. The sensor middleware system of claim 12, wherein the algorithms include genetic and adaptive algorithms, and wherein the algorithms include at least one of a guidance navigation and control algorithm, a visualization and pattern matching algorithm, a data mining algorithm, and a neural networking algorithm.

20. The sensor middleware system of claim 12, further comprising a communication interface coupled to mission services module and configured to receive and download algorithms for the mission services module.
